(19) United States
(12) Patent Application Publication
(10) Pub. No.: US 2013/0055108 A1
(43) Pub. Date: Feb. 28, 2013

(54) Managing an On-Line Conference Session

(71) Applicants: Sukadev Bhattiprolu, Beaverton, OR (US); Jujjuri Venkateswarara, Beaverton, OR (US); Haren Myneni, Beaverton, OR (US); Malahal R. Naineni, Beaverton, OR (US); Badari Pulavarty, Beaverton, OR (US); Chandra Seetharaman, Beaverton, OR (US); Narasimha Nageshrao Sharoff, Beaverton, OR (US)

(72) Inventors: Sukadev Bhattiprolu, Beaverton, OR (US); Jujjuri Venkateswarara, Beaverton, OR (US); Haren Myneni, Beaverton, OR (US); Malahal R. Naineni, Beaverton, OR (US); Badari Pulavarty, Beaverton, OR (US); Chandra Seetharaman, Beaverton, OR (US); Narasimha Nageshrao Sharoff, Beaverton, OR (US)

(73) Assignee: INTERNATIONAL BUSINESS MACHINES CORPORATION, Armonk, NY (US)

(21) Appl. No.: 13/222,325

(22) Filed: Aug. 31, 2011

(51) Int. Cl. G06F 3/048; G06F 15/16

(52) U.S. Cl. 715/753

(57) ABSTRACT

Embodiments of the invention relate to an on-line communication tool. A set of windows are employed to manage threads of communication. A first window maintains a list of threads available for discussion during the communication. A second window maintains a continuous log of the communication, and functions in a read-only mode. A third window maintains a read-write channel for a thread of the communication, and functions in a read-write mode. One or more threads may be selected from the first window, with each thread selection opening a separate third window. Text pertaining to a specific thread of the communication may be entered into the specific third window and populated to the continuous log of the second window.

### BACKGROUND

1. Technical Field

The present invention relates to a method and system for management of an on-line conference session. More specifically, the invention relates to a system and method that provides structure and contact to data associated with the on-line conference session.

2. Description of the Prior Art

With the advent of a global communication network of computers, on-line communication has become a popular platform for both business and personal communication. Different tools are available pertaining to different forms of the on-line communication. One form of communication is an on-line chat medium wherein the communication among users is supported in real-time over a network data processing system. Information in the on-line chat is typically communicated in the form of text and presented in a window on a visual display.

Another form of on-line communication pertains to on-line conferencing supported by an associated on-line conferencing tool. In general, participants with a computing device and a network connection can logon to a site hosting the on-line conference. The forms of communications supported include text and voice based communication. For example, the on-line conference may include presentation of a document, such as a slide show with voice communication supported to orally describe the content of the slide show. A window may be available for entering text, such as questions to the presenter of the content. Accordingly, users may participate in an on-line communication in real-time both in a conference environment as well as an on-line chat.

### SUMMARY OF THE INVENTION

This invention comprises a method, system, and apparatus for management of an on-line conference.

In one aspect of the invention, a method is provided for managing an on-line conference session. First and second windows are maintained on a visual display. The first window includes a list of threads available for discussion during the conference session, and the second window includes a continuous log of discussions associated with one or more of the thread identifiers listed in the first window. In one embodiment, the second window functions in a read-only mode. A separate read-write channel is opened for each selected thread identifier available in the list of available threads. In real-time, data related to a selected thread identifier is displayed in the separate read-write channel. Additionally, for a write mode of the separate channel, the selected thread identifier is embedded with all entered text. The entered text is populated from the separate channel into the continuous log of discussions in the second window.

In another aspect, a computer program product is provided. The computer program product includes a computer-readable storage medium having computer readable program code embodied thereon, which when executed causes a computer to implement a method for management of an on-line conference. More specifically, the computer program product supports maintenance of first and second windows on a visual display. The first window is configured to list threads available for discussion during the conference session. The second window is configured with a continuous log of discussions associated with one or more of the thread identifiers listed in the first window. The supported second window functions in a read-only mode. The computer program product is further configured to open a separate read-write channel for each thread identifier selected from the listing of available threads. More specifically, data related to a selected thread identifier is displayed in real-time in a separate read-write channel. In addition, the computer program product is further configured to support a write mode for the separate channels, including embedding the selected thread identifier with all entered text which is populated from the separate channel into the continuous log of discussion in the second window.

In yet another aspect, a system is provided with a processor in communication with memory. A functional unit is provided in communication with the memory and includes tools to support on-line conferencing. More specifically, the functional unit includes a first window manager to maintain a first window on a visual display, and a second window manager to maintain a second window on the visual display. The first window exhibits a list of threads available for discussion during a conference session. The second window exhibits a continuous log of discussions associated with the thread identifiers listed in the first window. The second window functions in a read-only mode. In addition, the functional unit includes a conference manager to open a separate read-write channel for each selected thread identifier from the listing of available threads. More specifically, the conference manager displays data pertaining to a selected thread identifier in a separate read-write channel in real-time. For a write mode of the separate channel, the conference manager embeds the selected thread identifier with all entered text and populates the entered text from the separate channel into the continuous log of discussions in the second window.

Other features and advantages of this invention will become apparent from the following detailed description of the presently preferred embodiment of the invention, taken in conjunction with the accompanying drawings.

### BRIEF DESCRIPTION OF THE DRAWINGS

The drawings referenced herein form a part of the specification. Features shown in the drawings are meant as illustrative of only some embodiments of the invention, and not of all embodiments of the invention unless otherwise explicitly indicated. Implications to the contrary are otherwise not to be made.

FIG. 1 depicts a flow chart illustrating a process for organizing one or more threads of a conversation to be scheduled.

FIG. 2 depicts a block diagram illustrating an example window of a real-time conversation log.

FIG. 3 depicts a flow chart illustrating a process for adding a new thread to the conversation.

FIG. 4 depicts a flow chart illustrating how a participant participates in the conversation with text associated with the participation reflected in the read-only window.

FIG. 5 depicts a flow chart illustrating the process of assigning threads to participants.

FIG. 6 depicts a flow chart illustrating a process for adding one or more participants to a conference and assignment of one or more threads to the added participant(s).

FIG. 7 depicts a flow chart illustrating a process for engaging in an on-line conversation with assignment of threads to select participants, and the functionality of an associated read-write window.

FIG. 8 depicts a flow chart illustrating a process for loading the log from storage and parsing the continuous log for one or more select threads.

FIG. 9 depicts a block diagram illustrating tools embedded in a computer system to support management of an on-line conference.

FIG. 10 is a block diagram showing a system for implementing an embodiment of the present invention.

### DETAILED DESCRIPTION

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

The functional unit described in this specification has been labeled with tools, modules, and/or managers. The functional unit may be implemented in programmable hardware devices such as field programmable gate arrays, programmable array logic, programmable logic devices, or the like. The functional unit may also be implemented in software for execution by various types of processors. An identified functional unit of executable code may, for instance, comprise one or more physical or logical blocks of computer instructions which may, for instance, be organized as an object, procedure, function, or other construct. Nevertheless, the executable of an identified functional unit need not be physically located together, but may comprise disparate instructions stored in different locations which, when joined logically together, comprise the functional unit and achieve the stated purpose of the functional unit.

Indeed, a functional unit of executable code could be a single instruction, or many instructions, and may even be distributed over several different code segments, among different applications, and across several memory devices. Similarly, operational data may be identified and illustrated herein within the functional unit, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, such as examples of modules, managers, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

In the following description of the embodiments, reference is made to the accompanying drawings that form a part hereof, and which shows by way of illustration the specific embodiment in which the invention may be practiced. It is to be understood that other embodiments may be utilized because structural changes may be made without departing form the scope of the present invention.

On-line communication tools that support various forms of communication are becoming abundantly popular for conducting business. Message based communication between two or more people employing separate electronic devices can come in different forms, including but not limited to, text based messaging of portable telecommunication devices, non-real-time electronic mail communication, and real-time direct text-based communication between two or more people. Other forms of text based communication may exist, and as such, the examples shown herein are not considered limiting. The message based communication supports communication via text in place of or supplementary to voice based communication. Real-time direct text-based communication emulates a conversation in a text form as opposed to a verbal form. In effect, each of these forms of communication employ a conduit between two electronic devices and supports real-time transmission of messages.

In the text message based communication, a window is employed on a visual display to display a log conveying an associated conversation among the participants in the communication. The window may come in various forms and configuration, but in general displays a continuous log of all communication transpiring among all of the participants. A participant in the communication can access and/or view the continuous log to review the content of the conversation. In one embodiment, the log may be saved for review at a later point-in-time. Accordingly, the log enables a user to maintain a written copy of the conversation in real-time, or save the copy of the log for review at a later time.

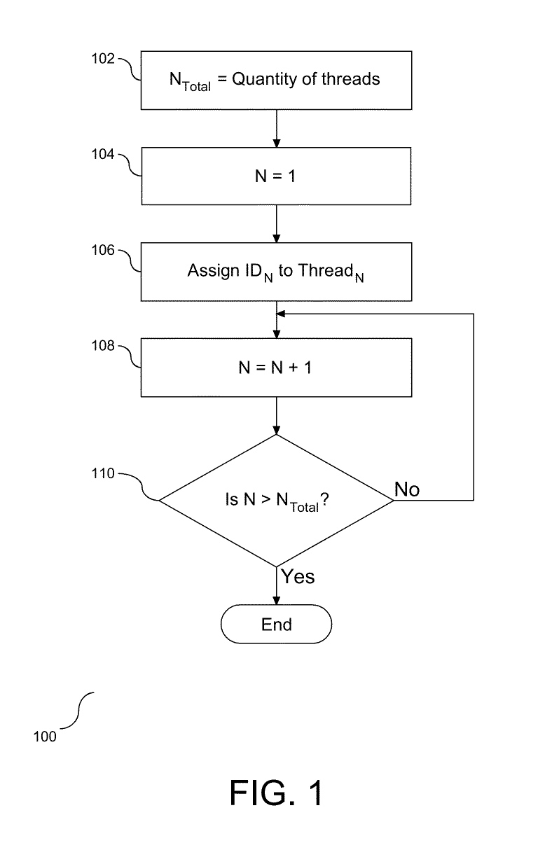

The communication is enhanced by creating one or more secondary display windows to support different threads of the conversation, while continuing to maintain a central log that combines each of the separate threads into a single continuous log. Conversations may be scheduled to take place at a certain point-in-time, or they may occur without prior scheduling. FIG. 1 is a flow chart (100) illustrating a process for organizing one or more threads of a conversation to be scheduled. In one embodiment, when a conversation is scheduled on a calendar to take place on a specific day and at a specific time, there are one or more threads scheduled to be discussed during the conversation. Each of these threads is referred to herein as a thread. The variable N_{Total} is assigned to the quantity of threads to be discussed and therefore maintained during the conversation (102), and a counting variable, N, is assigned to the integer one (104). An identifier, ID_{N}, is assigned to each thread, Thread_{N} (106). In one embodiment, the identifier is a numerical value assigned to each thread. Following step (106), the counting variable N is incremented (108). It is then determined if each of the defined threads have been assigned an identifier (110). A negative response to the determination at step (110) is followed by a return to step (106). Conversely, a positive response to the determination at step (110) concludes the process of assigning an identifier to each pre-defined thread. Accordingly, as shown herein, a scheduled conversation may include one or more defined threads of conversation to be discussed, with each defined thread having an associated identifier.

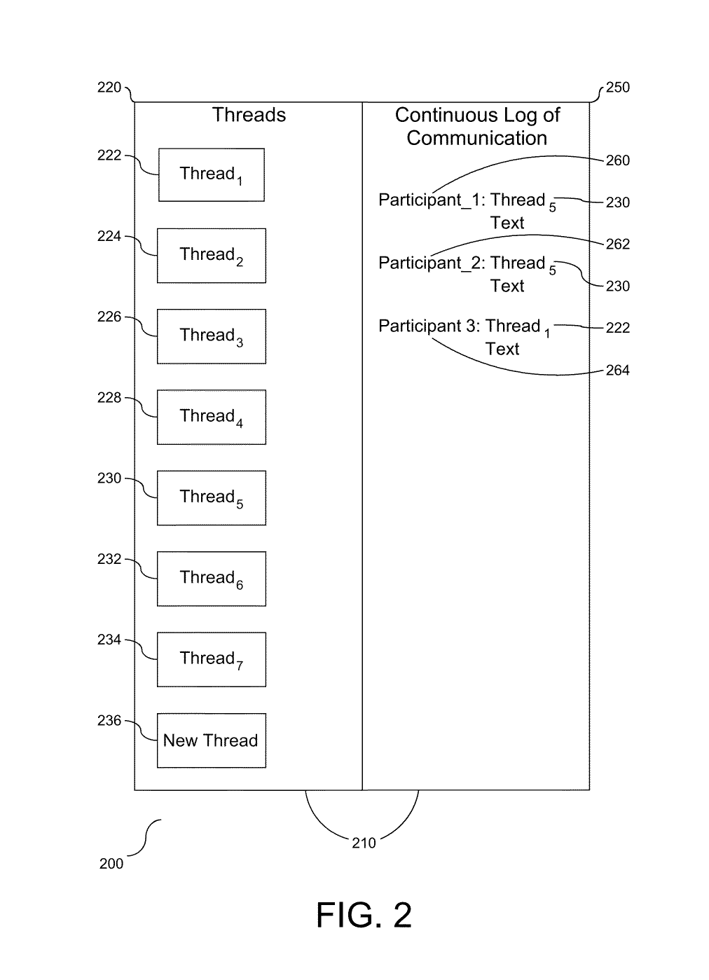

Each of the defined threads and their associated identifiers are incorporated into the conversation log in real-time. FIG. 2 is a block diagram (200) illustrating an example window of a real-time conversation log. As shown, the window (210) is divided into two sections (220) and (250). A first section (220) includes a list of threads. In the example shown herein, seven threads (222)-(234) are pre-defined for the conversation. Each of the threads (222)-(234) may include descriptive indicia so that the participants in the conversation can identify the subject matter of the respective thread. Additionally, each of the threads (222)-(234) includes an associated identifier (not show). As shown in FIG. 1, each thread is assigned an identifier. In one embodiment, the identifier may be in the form of an alphanumeric string, a number, etc. The second section (250) includes a continuous log of the conversation in real-time. In one embodiment, the second section (250) is a read-only display that includes a rolling text of the conversation in real-time. Similarly, in one embodiment, the first section (220) may be in the form of a first window, and the second section (250) may be in the form of a second window, with the first and second windows being separate frames on a visual display. Accordingly, the first and second sections (220) and (250), respectively, illustrate pre-defined threads of conversation, together with a chronological rolling text of the conversation.

As a conversation employs at least two participants, rolling text of the conversation in the second section (250) may include a participant associated with a specific section of the conversation. In addition, as the threads of conversation are predefined, each section of the conversation may include indicia associating the section of the conversation with at least one of the pre-defined threads. As shown in FIG. 2, each of the participants is identified with their associated contributions to the conversation, together with section indicia. More specifically, the conversation is initiated with a first participant (260) with the conversation pertaining to one of the threads (230). A second participant (262) contributes to the conversation after the first participant (260) and along the same thread (230). However, a third participant (264) adds to the conversation pertaining to thread (222). In one embodiment, one or more of the participants may activate a new thread (236). Although the new thread (236) is not pre-defined for the conversation, the new thread (236) may include descriptive indicia so that the participants in the conversation can identify the subject matter of the new thread. At the same time, activation of the new thread (236) by one of the participants will populate the new thread to all of the participants in the conversation. Accordingly, as demonstrated, as each thread is referenced by a participant, the thread identifier or associated indicia is referenced in the chronological conversation of the second section (250).

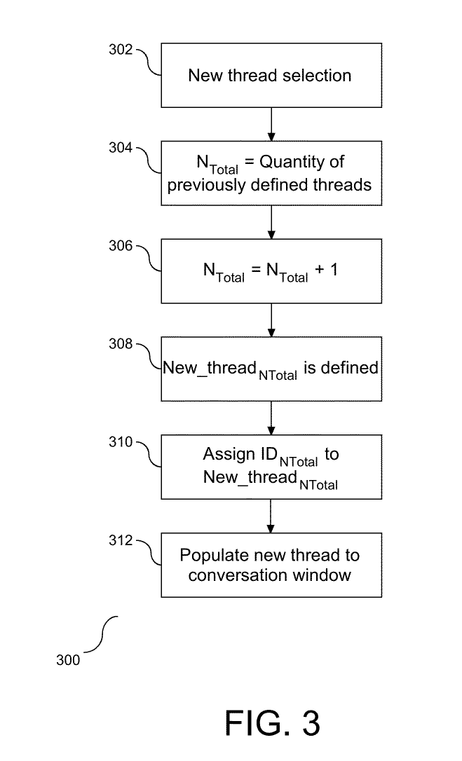

Threads for a conversation may be pre-defined, as shown in FIG. 1. In one embodiment, threads may be added to the conversation, with each new thread communicated and made available to each participant in the conversation. FIG. 3 is a flow chart (300) illustrating a process for adding a new thread to the conversation. A participant or administrator of the conversation selects to add a new thread (302). The quantity of previously defined threads is represented by the variable N_{Total} (304), the variable N_{Total} is incremented (306), and the new thread, new_thread_{NTotal}, is defined with one or more descriptive characteristics (308). A new identifier, ID_{NTotal}, is assigned to the defined new_thread_{NTotal} (310). Following step (310), the new thread has been created and initialized, and it is populated to the first section (220) of the conversation window that includes a list of threads (312). Once the conversation window is populated with the new thread, it is available for all of the participants of the conversation. In one embodiment, the new thread is created and populated in real-time during the conversation. Accordingly, a new thread may be dynamically added to the conversation, with the new thread dynamically populated to the conversation window and available to every participant in the conversation.

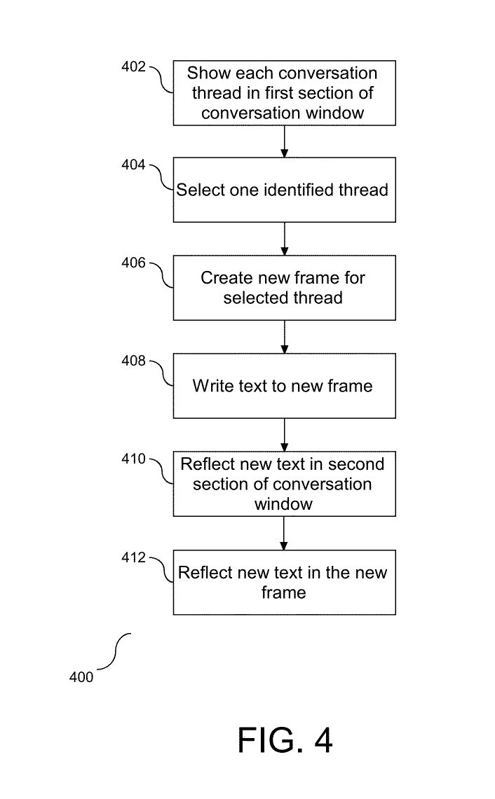

As the conversation takes place, text pertaining to the conversation is displayed as a conversation log in real-time in a window. Each participant can read the conversation text in a window on each of their respective visual display. However, the conversation is a read-only window. FIG. 4 is a flow chart (400) illustrating how a participant participates in the conversation with text associated with the participation reflected in the read-only window. Each of the threads of conversation is shown in a first section of the conversation window (402). A participant in the conversation, who wants to contribute to the conversation with respect to a listed thread, may select one of the threads from the first section (404). This selection creates a new frame on the visual display of the participant (406), which in one embodiment is a channel of the conversation.

The new frame is a read-write frame, which in one embodiment allows the participant to write text to the read-write frame (408), with the new text reflected in real-time in both the second section of the conversation window (410) as well as in the new frame (412). In one embodiment, all text that was previously entered in the conversation for the selected thread is displayed in the new frame in chronological order. Since the new text pertains to a selected thread, the associated thread identifier is embedded within the new text in the conversation window. In one embodiment, the aspect of writing text to the new frame is referred to as a meeting mode. Similarly, in one embodiment, for each separate thread of conversation as defined by the respectively define threads in the conversation window a separate read-write frame is created. Accordingly, the thread identifiers are associated with each read-write frame and populated to the conversation window chronologically in real-time to enable all of the participants to watch the meeting as the meeting evolves.

As shown in FIG. 4, each participant may select a thread in the conversation window, with the selection causing opening of a read-write frame for the selected thread. However, each participant may engage in two or more threads within the conversation. To support multiple thread engagement, the participant may select two or more threads with each thread selection causing an opening of a separate read-write channel, e.g. a separate new frame, for the subject thread. Accordingly, multiple read-write channels may be employed by a single participant in the conversation.

Furthermore, FIG. 4 demonstrates a process for a participant to select a thread in order to actively engage in the conversation. For various reasons, it may be desirable to assign specific threads of the conversation to specific participants by assigning one or more threads to an identified participant. The assignment includes opening of a read-write channel for the assigned thread when the participant is actively or passively involved in the conversation.

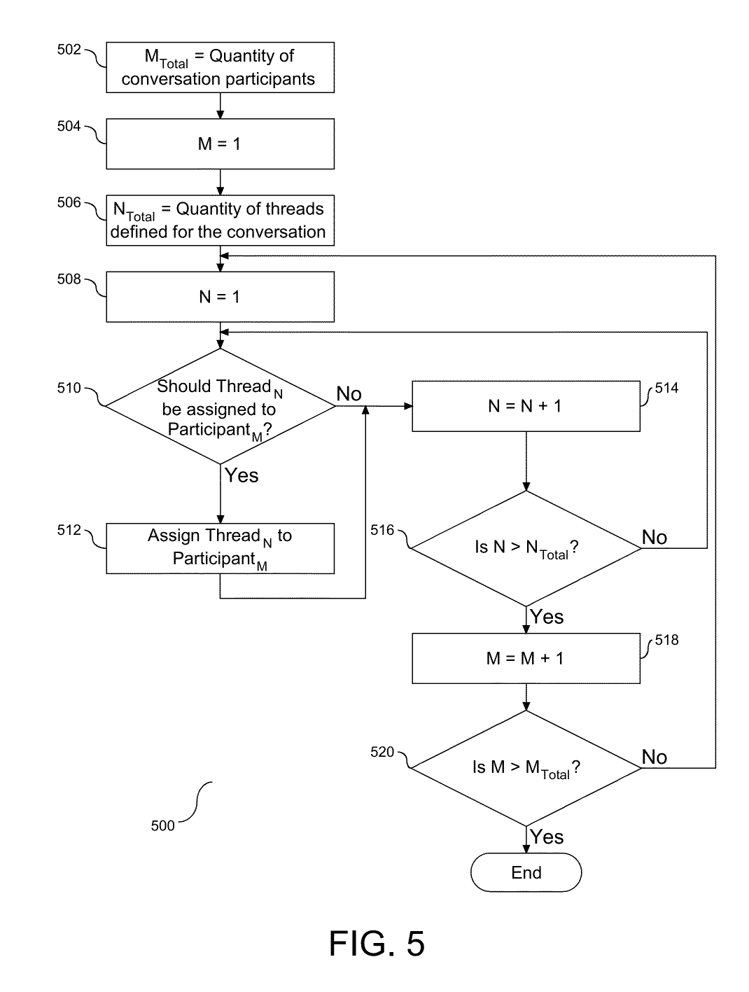

FIG. 5 is a flow chart (500) illustrating a process of assigning threads to participants. The assignment may take place prior to starting the conversation, during the conversation, as new participants join the conversation, etc. The variable M_{Total} is assigned to the quantity of participants designated to participate in the conversation (502), and an associated counting variable is assigned to the integer one (504). Similarly, the variable N_{Total} is assigned to the quantity of threads designated for the conversation (506), and an associated counting variable is assigned to the integer one (508). It is then determined if thread_{N} should be assigned to participant_{M} (510). A positive response to the determination at step (510) is followed by assigning thread_{N} to participant_{M} (512). However, a negative response to the determination at step (510) is followed by an increment of the counting variable N (514), and a determination if all of the threads have been evaluated for assignment to participants (516). A negative response to the determination at step (516) is followed by a return to step (510). Conversely, a positive response to the determination at step (516) is followed by an incrementing of the counting variable M representing participants (518) and a determination if all of the participants have been evaluated for the set of discussion threads (520). A negative response to the determination at step (520) is followed by a return to step (508), and a positive response to the determination at step (520) concludes the thread assignment process. Accordingly, for each participant, one or more threads of discussion may be assigned prior to the discussion.

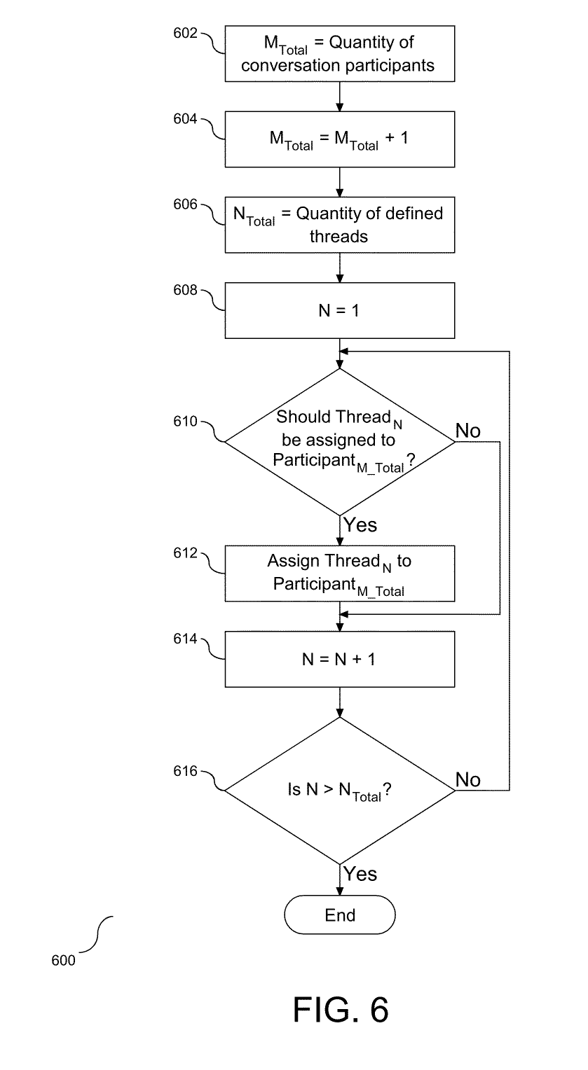

It is recognized that participants and thread of a conversation may change. More specifically, a conference may be scheduled with a select set of participants. Prior to or during the conference one or more participants may be added to participate. Similarly, and as demonstrated above, the threads to be discussed may change prior to or during the conference. FIG. 6 is a flow chart (600) illustrating a process for adding one or more participants to a conference and assignment of one or more threads to the added participant(s). The variable M_{Total} represents the quantity of participants in the conference (602). As each participant, M, is added to the conference, the variable M_{Total} is incremented (604). Similarly, the variable N_{Total} represents the quantity of threads set to be discussed during the conference (606), and an associated counting variable, N, is set to the integer one (608). Following step (608), the assignment of threads to the new participant takes place. In one embodiment, it is determined if thread_{N} is to be assigned to participant_{M}_{_{—}}_{Total} (610). A positive response to the determination at step (610) is followed by the assignment of the select thread to the subject participant (612). However, following a negative response to the determination at step (610) or following step (612), the counting variable pertaining to the threads of the conference, N, is incremented (614). Accordingly, multiple threads may be assigned to one or more participants.

Following assignment of individual threads, it is then determined if all of the threads have been reviewed for assignment (616). A negative response to the determination at step (616) is followed by a return to step (610). Conversely, a positive response to the determination at step (616) concludes the process of assigning thread of the conference to a newly added participant. In one embodiment, not all threads will be assigned to at least one participant. Such a thread may be removed indicating that the thread is not relevant to the conference, or the subject of the thread has been removed from an associated conference agenda. Alternatively, the unassigned thread(s) may remain for deferred assignment to a current participant or a future participant to be added. Accordingly, as participants are added to the conference, one or more select threads may be assigned to the added participant(s).

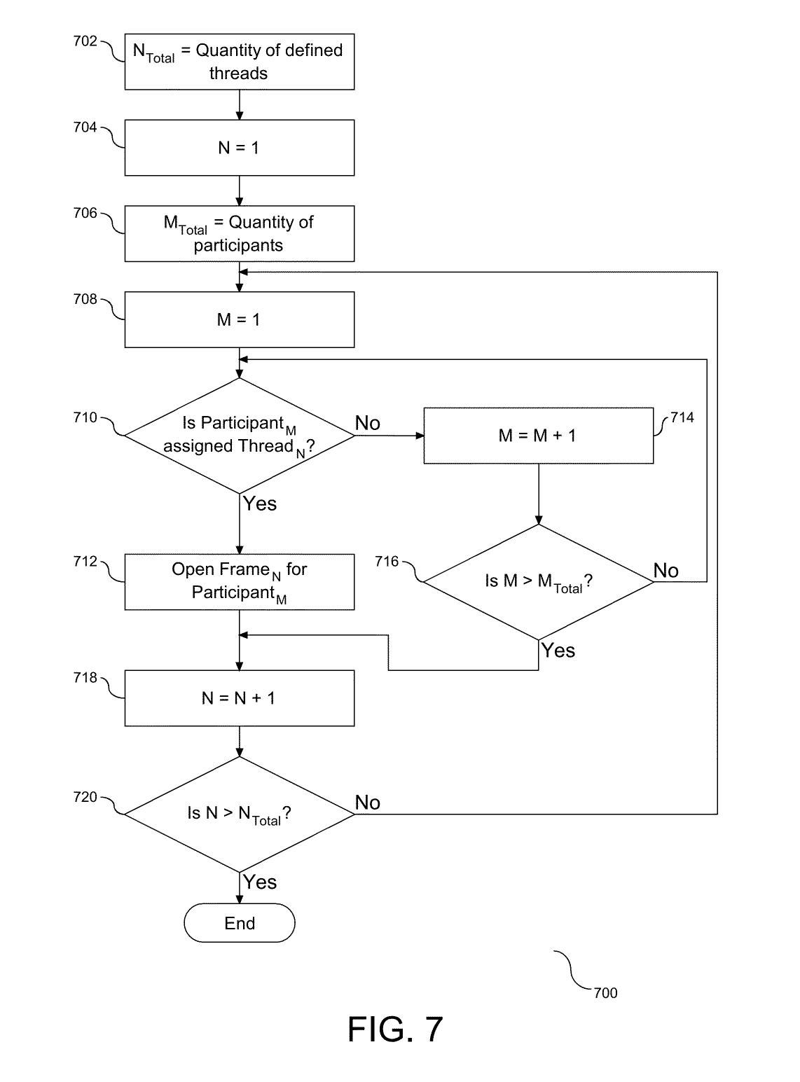

As explained herein, each participant may have one or more threads assigned to them, thereby enabling such participant(s) to open a read-write window, i.e. channel, for the subject thread. FIG. 7 is a flow chart (700) illustrating a process for engaging in an on-line conversation with assignment of threads to select participants, and the functionality of an associated read-write window. The variable N_{Total} is assigned to the quantity of defined threads for the conversation (702), and an associated counting variable N is assigned to the integer one (704). Similarly, the variable M_{Total} is assigned to the quantity of participants in the conversation (706), and an associated counting variable M is assigned to the integer one (708). It is determined if participant_{M} is assigned thread_{N} (710). A positive response to the determination at step (710) is followed by opening a frame, frame_{M} for participant_{M}, with the opened frame pertaining to the specific thread (712). However, a negative response to the determination at step (710) is followed by incrementing the counting variable M (714), and determining if all of the participants have been evaluated for thread_{N} (716). A negative response to the determination at step (716) is followed by a return to step (710). However, a positive response to the determination at step (716) or following step (712), the counting variable N is incremented (718), followed by determining if all of the threads have been evaluated (720). A negative response to the determination at step (720) is followed by a return to step (708), and a positive response to the determination at step (720) concludes the process of opening separate thread frames for select participants and associated threads.

As shown herein, a visual display may be segregated into different windows or frames to support and organize an on-line conference and associated communication. Each of the windows or frames has different properties to support the conference. More specifically, one of the frames maintains a continuous log of all communications in the conference, and functions in a read-only mode. Another one of the frames maintains a list of all threads that are the subject of the conference. Communication associated with one of the specified threads is entered through a secondary window created for each of the specified threads. More specifically, each participant may create a window in the form of a channel with read-write properties for a specified thread, with each channel having a one-on-one correspondence to one of the threads identified in the frame of the visual display that identifies all of the threads of the conference. Accordingly, multiple windows are provided to support the on-line conference organization, together with creation of one or more channels for one or more selected threads, respectively, with the windows functioning in a read only mode and each of the channels functioning in a read-write mode.

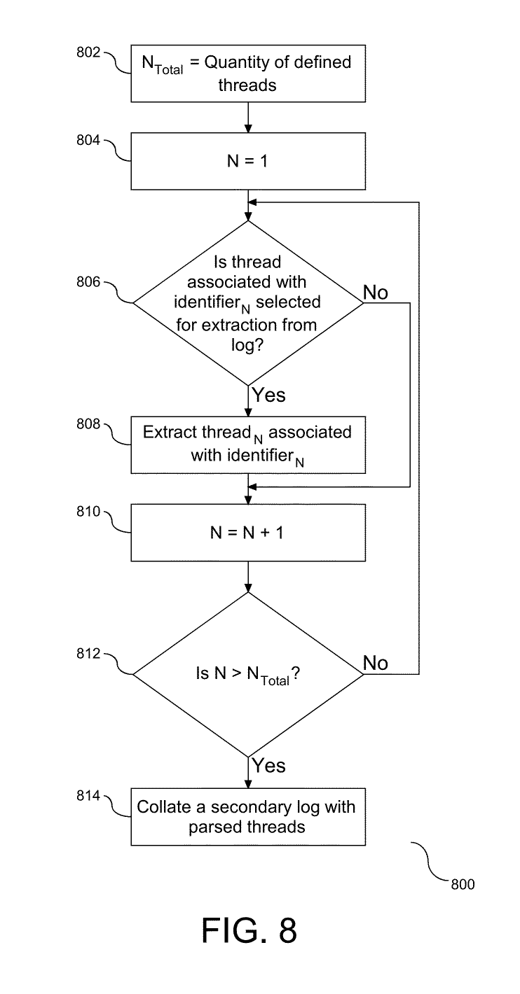

The continuous log of the conference is stored in persistent storage. After the conference has concluded, the log may be retrieved from storage for review. As noted above, each entry in the log has an identifier pertaining to one of the defined threads, whether it is an original thread or a later added thread. FIG. 8 is a flow chart (800) illustrating a process for loading the log from storage and parsing the continuous log for one or more select threads. The variable N_{Total} represents the quantity of defined threads (802), and a counting variable N is set to the integer one (804). It is then determined if the thread associated with identifier_{N} is selected to be extracted from the log (806). A positive response to the determination at step (806) is followed by extraction of the thread associated with identifier (808). The extraction includes all data that has been entered into the continuous log from a channel assigned to the identifier. Following step (808) or a negative response to the determination at step (806), the counting variable N is incremented (810). It is then determined if all of the defined threads have been reviewed for extraction (812). A negative response to the determination at step (812) is followed by a return to step (806). However, a positive response to the determination at step (812) concludes the extraction of the thread identifiers and is followed by collating a secondary log with threads parsed from the continuous log with the parsing based upon the extracted identifiers (814). Accordingly, the identification and extraction of threads may be based on a single thread selection at a time, and accommodating multiple threads in the final secondary log.

As an alternative to the extraction shown in FIG. 8, in one embodiment all of the thread and/or their associated identifiers may be presented in a single presentation to one or more participants in the conference. Each participant may select those threads that they want to review in a secondary log. This results in a parsing of the continuous log, excluding all non-selected threads from the log, and creating a secondary log with only those selected threads present. Accordingly, a secondary log is created based upon a participant initiated parsing of the continuous log so that the participant may focus their review of the conference on those threads they consider pertinent.

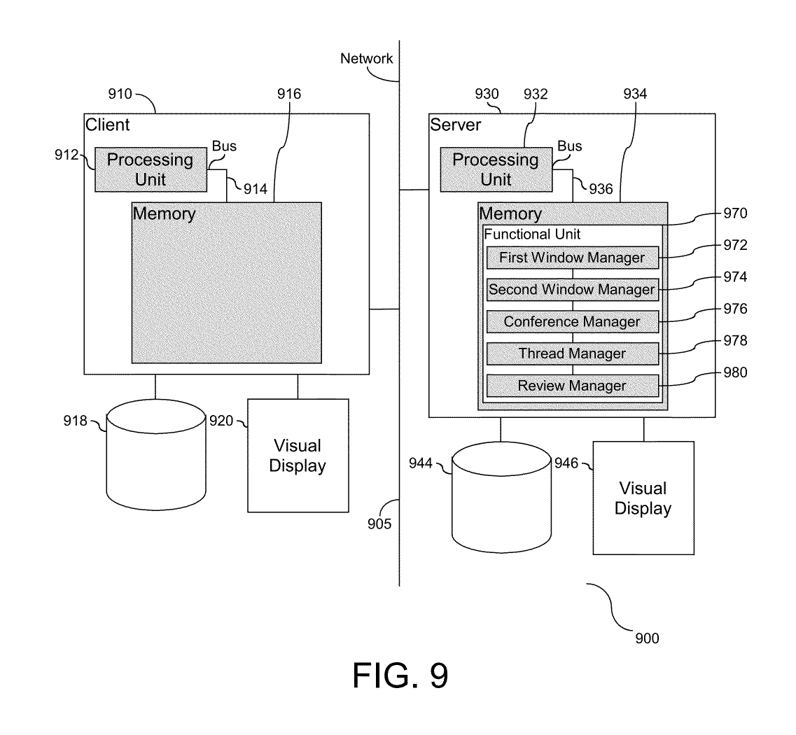

Management and support of an on-line conference may take place between a client machine and a server and/or designated data storage device, with the functionality of the management and support maintained by the server. FIG. 9 is a block diagram (900) illustrating tools embedded in a computer system to support management of an on-line conference. For illustrative purposes, a computer system is provided with a client machine (910) in communication with a server (930) across a network (905). The client machine (910) is provided with a processing unit (912) in communication with memory (916) across a bus (914). In one embodiment, client machine (910) is in communication with local data storage (918) and a visual display (920).

The client machine (910) is shown in communication with the server (930) across the network (905). In one embodiment, the server (930) is in a data center in a shared pool of configurable resources. The server (930) is provided with a processing unit (932) in communication with memory (934) across a bus (936). As shown herein, the server (930) is in communication with at least one storage device (944) and a visual display (946). In one embodiment, the server (930) may be in communication with additional storage devices, and/or additional data centers. The storage device (944) is configured to support read and/or write operations.

A functional unit (970) is provided in communication with memory (934); the functional unit (970) supports management of an on-line conference. As shown, the functional unit (970) is provided with a first window manager (972), a second window manager (974), a conference manager (976), a thread manager (978), and a review manager (980). The first window manager (972) functions to maintain a first window on the visual display (946), and the second window manager (974) functions to maintain a second read-only window on the visual display (946). The first window exhibits a list of threads available for discussion during a conference session, and the second window exhibits a continuous log of discussions for each of the associated thread identifiers listed in the first window.

The conference manager (976) functions to manage one or more read-write channels in the conference. More specifically, the conference manager (976) opens a separate read-write channel for each thread identifier selected from the list of thread identifiers represented in the first window by the first window manager (972). In one embodiment, the conference manager (976) may simultaneously open and support two or more separate read-write channels. Data associated with the thread identifier of a created channel is populated in real-time in the subject channel. More specifically, the conference manager (976) displays data related to a selected thread identifier in the created channel. For data written to the channel, in real-time the conference manager (976) populates the entered text from the channel into the continuous log in the second window managed by the second window manager (974). Accordingly, multiple windows and channels are provided together with associated managers to organize and support a multiple thread on-line conference.

The thread manager (978) is provided as a tool in communication with the conference manager (976). More specifically, the thread manager (978) functions to automatically assign a thread to a participant in the conference. The thread manager (978) automates opening of the separate read-write channel for the assigned thread(s) to the respective participants. In one embodiment, the separate channels are only visible on the visual display of the client machine associated with the participants, with the thread manager (978) to open a channel in the form of a frame on the client visual display. Similarly, as discussed above, the threads and threads may be added to the conference so that the tools support the dynamic nature of a conference. The thread manager (978) dynamically adds a new thread to the list of threads represented by the second window manager (974). As the new threads is added to the conference, the thread manager (978) functions to populate the list of all of the threads to each participant in the conference session. Accordingly, the thread manager (978) supports the dynamic nature of the conference.

In general, all conferences have some shared characteristics, whether the conference takes place on-line or in-person. That is, all conferences have a beginning and an end. As noted, the first window manager (972) maintains a window of the continuous log of the conference. The review manager (980) is provided in communication with the conference manager (976) to enable a delayed review of the conference. More specifically, the conference is an on-line conference and all of the communication is saved in storage device (944). The review manager (980) recaps a prior meeting by loading the continuous log from storage device (944). In one embodiment, the review manager (980) may segregate the recap based upon a specified thread identifier to provide a view of the log different from the continuous format. Accordingly, the review manager may provide different formats to recap the conference, including but not limited to, a continuous log in the order of the conference communication or a log segregated based upon one or more specified thread identifiers.

It is understood that data for the conference may be input through different formats. Two general formats include, but are not limited to, text and voice. Text may be entered through a keyboard in communication with the client machine (910) and reflected in the specific channel and the associated log. The conference manager (976) supports entering text into a specific channel through a resource in communication with the client machine (910). In one embodiment, the resource may be in the form of a microphone to allow audio input of data into the specified channel. Accordingly, data input should not be limited to use of a keyboard, stylus, or other text input device.

As identified above, the first window manager (972), second window manager (974), conference manager (976), thread manager (978), and review manager (980), hereinafter referred to as tools, function as elements to support the on-line conference communication. The tools (972)-(980) are shown residing in memory (934) local to the server (930). However, the tools (972)-(980) may reside as hardware tools external to memory (934), or they may be implemented as a combination of hardware and software. Similarly, in one embodiment, the tools (972)-(980) may be combined into a single functional item that incorporates the functionality of the separate items. As shown herein, each of the tools (972)-(980) are shown local to the server (930). However, in one embodiment they may be collectively or individually distributed across a network or multiple machines and function as a unit to evaluate hardware performance. Accordingly, the managers may be implemented as software tools, hardware tools, or a combination of software and hardware tools.

As will be appreciated by one skilled in the art, aspects of the present invention may be embodied as a system, method or computer program product. Accordingly, aspects of the present invention may take the form of an entirely hardware based embodiment, an entirely software based embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

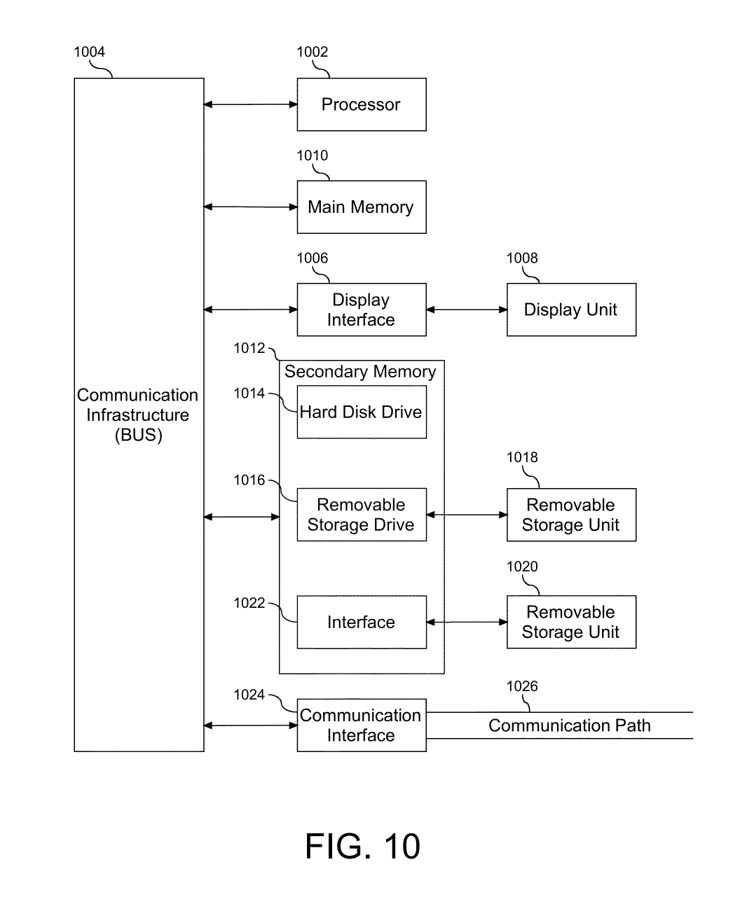

Referring now to the block diagram of FIG. 10, additional details are now described with respect to implementing an embodiment of the present invention. The computer system includes one or more processors, such as a processor (1002). The processor (1002) is connected to a communication infrastructure (1004) (e.g., a communications bus, cross-over bar, or network).

The computer system can include a display interface (1006) that forwards graphics, text, and other data from the communication infrastructure (1004) (or from a frame buffer not shown) for display on a display unit (1008). The computer system also includes a main memory (1010), preferably random access memory (RAM), and may also include a secondary memory (1012). The secondary memory (1012) may include, for example, a hard disk drive (1014) and/or a removable storage drive (1016), representing, for example, a floppy disk drive, a magnetic tape drive, or an optical disk drive. The removable storage drive (1016) reads from and/or writes to a removable storage unit (1018) in a manner well known to those having ordinary skill in the art. Removable storage unit (1018) represents, for example, a floppy disk, a compact disc, a magnetic tape, or an optical disk, etc., which is read by and written to by removable storage drive (1016). As will be appreciated, the removable storage unit (1018) includes a computer readable medium having stored therein computer software and/or data.

In alternative embodiments, the secondary memory (1012) may include other similar means for allowing computer programs or other instructions to be loaded into the computer system. Such means may include, for example, a removable storage unit (1020) and an interface (1022). Examples of such means may include a program package and package interface (such as that found in video game devices), a removable memory chip (such as an EPROM, or PROM) and associated socket, and other removable storage units (1020) and interfaces (1022) which allow software and data to be transferred from the removable storage unit (1020) to the computer system.

The computer system may also include a communications interface (1024). Communications interface (1024) allows software and data to be transferred between the computer system and external devices. Examples of communications interface (1024) may include a modem, a network interface (such as an Ethernet card), a communications port, or a PCMCIA slot and card, etc. Software and data transferred via communications interface (1024) are in the form of signals which may be, for example, electronic, electromagnetic, optical, or other signals capable of being received by communications interface (1024). These signals are provided to communications interface (1024) via a communications path (i.e., channel) (1026). This communications path (1026) carries signals and may be implemented using wire or cable, fiber optics, a phone line, a cellular phone link, a radio frequency (RF) link, and/or other communication channels.

In this document, the terms “computer program medium,” “computer usable medium,” and “computer readable medium” are used to generally refer to media such as main memory (1010) and secondary memory (1012), removable storage drive (1016), and a hard disk installed in hard disk drive (1014).

Computer programs (also called computer control logic) are stored in main memory (1010) and/or secondary memory (1012). Computer programs may also be received via a communication interface (1024). Such computer programs, when run, enable the computer system to perform the features of the present invention as discussed herein. In particular, the computer programs, when run, enable the processor (1002) to perform the features of the computer system. Accordingly, such computer programs represent controllers of the computer system.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed.

Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

### Alternative Embodiment

It will be appreciated that, although specific embodiments of the invention have been described herein for purposes of illustration, various modifications may be made without departing from the spirit and scope of the invention. In particular, the system can be configured to employ threads and associated identifiers to collate a meeting agenda prior to the conference or as a synopsis recap following the conference. Accordingly, the scope of protection of this invention is limited only by the following claims and their equivalents.

We claim:

1. A method for managing an on-line conference session, comprising:
maintaining a first window on a visual display with a listing of threads available for discussion during the conference session;
maintaining a second window on the visual display with a continuous log of discussions for all thread identifiers listed in the first window, wherein the second window functions in a read-only mode;
opening a separate read-write channel for each selected thread identifier from the listing of available threads, and in real-time displaying data pertaining to a selected thread identifier in the separate read-write channel, and for a write mode of the separate channel embedding the selected thread identifier with all entered text and populating the entered text from the separate channel in the continuous log of discussions in the second window.

2. The method of claim 1, further comprising automatically assigning a thread to a participant, including opening the separate read-write channel for the automatically assigned thread.

3. The method of claim 1, further comprising dynamically adding a new thread to the listing of available threads, including populating the list with the new thread to each participant in the conference session.

4. The method of claim 1, further comprising simultaneously opening and supporting at least two separate read-write channels.

5. The method of claim 1, further comprising recapping a prior meeting including loading prior discussion log data associated with a specified thread identifier.

6. The method of claim 1, further comprising associating a resource with the separate read-write channel and allowing for data input in the channel with use of the resource.

7. A computer program product comprising a computer readable storage medium having computer readable program code embodied therewith, the computer readable program code comprising:
computer readable program code configured to maintain a first window on a visual display with a listing of threads available for discussion during the conference session;
computer readable program code configured to maintain a second window on the visual display with a continuous log of discussions for all thread identifiers listed in the first window, wherein the second window functions in a read-only mode;
computer readable program code configured to open a separate read-write channel for each selected thread identifier from the listing of available threads, and in real-time displaying data pertaining to a selected thread identifier in the separate read-write channel, and for a write mode of the separate channel embedding the selected thread identifier with all entered text and populating the entered text from the separate channel in the continuous log of discussions in the second window.

8. The computer program product of claim 7, further comprising computer program code to automatically assign a thread to a participant, including opening the separate read-write channel for the automatically assigned thread.

9. The computer program product of claim 7, further comprising computer product code to dynamically add a new thread to the listing of available threads, including populating the list with the new thread to each participant in the conference session.

10. The computer program product of claim 7, further comprising computer program code to simultaneously open and support at least two separate read-write sub-channels.

11. The computer program product of claim 7, further comprising computer program code to recap a prior meeting including loading prior discussion log data associated with a specified thread identifier.

12. The computer program product of claim 7, further comprising computer program code to associate a resource with the separate read-write channel and allowing for data input in the channel with use of the resource.

13. A system comprising:
a processor in communication with memory;
a functional unit in communication with the memory, the functional unit comprising:
a first window manager to maintain a first window on a visual display, the first window to exhibit a list of threads available for discussion during the conference session;
a second window manager to maintain a second window on the visual, the second window to exhibit a continuous log of discussions for all thread identifiers listed in the first window, wherein the second window functions in a read-only mode; and
a conference manager to open a separate read-write channel for each selected thread identifier from the listing of available threads, and in real-time the conference manager to display data pertaining to a selected thread identifier in the separate read-write channel, and for a write mode of the separate channel the conference manager to embed the selected thread identifier with all entered text and to populate the entered text from the separate channel in the continuous log of discussions in the second window.

14. The system of claim 13, further comprising a thread manager in communication with the conference manager, the thread manager to automatically assign a thread to a participant, including the thread manager to open the separate read-write channel for the automatically assigned thread.

15. The system of claim 13, further comprising a thread manager in communication with the conference manager, the thread manager to dynamically add a new thread to the listing of available threads, including populating the list with the new thread to each participant in the conference session.

16. The system of claim 13, further comprising the conference manager to simultaneously open and support at least two separate read-write channels.

17. The system of claim 13, further comprising review manager in communication with the conference manager, the review manager to recap a prior meeting
including loading prior discussion log data associated with a specified thread identifier.

18. The system of claim 13, further comprising the conference manager to associate a resource with the separate read-write channel and to allow for data input in the channel with use of the resource.
